(19) United States
(12) Patent Application Publication
(10) Pub. No.: US 2019/0085882 A1
(43) Pub. Date: Mar. 21, 2019

(54) Decorative Item Fastener

(71) Applicant: Marie Martin, Caremore, OK (US)

(72) Inventor: Marie Martin, Caremore, OK (US)

(21) Appl. No.: 16/107,257

(22) Filed: Aug. 21, 2018

Related U.S. Application Data
(60) Provisional application No. 62/559,891, filed on Sep. 18, 2017.

(51) Int. Cl. F16B 2/10; F16B 35/06

(52) U.S. Cl. CPC F16B 2/10; F16B 35/06

(57) ABSTRACT

A decorative item fastener secures a secondary decorative item to a primary decorative item, without altering the body of either decorative item. The decorative item fastener includes a holder, a cylindrical male fastener, and an annular female fastener. The holder that secures the secondary decorative item includes a first arm, a second arm, and a recoil member as the first arm and the second arm are tensionably and hingedly connected to each other with the recoil member. A first section of the cylindrical male fastener is terminally connected to the second arm, opposite of the first arm. A second section of the cylindrical male fastener is engaged with the annular female fastener. The cylindrical male fastener and the annular female fastener collectively secures the decorative item fastener to the primary decorative item.

The current application claims a priority to the U.S. Provisional Patent application Ser. No. 62/559,891 filed on Sep. 18, 2017.

### FIELD OF THE INVENTION

The present invention relates generally to holders and fasteners. More specifically, the present invention allows an individual to attach a secondary item to a main decorative item without tools or modifying the body of the main decorative item.

### BACKGROUND OF THE INVENTION

Some decorative pieces are temporary or seasonal pieces, which are mounted onto walls or other surfaces, using various types of fasteners. Additional decorative items are often mounted onto the already installed decorative pieces. For example, wreaths are decorative pieces mounted on doors or walls to express seasonal or annual themes. Additional items such as ribbons or flowers are usually added to the surfaces of the wreath to embellish the wreath according to a theme such as Christmas or Fall. Existing fasteners used to attach the additional items to the decorative piece include zip ties, glue, screws, and other similar fasteners. Unfortunately, most of the fasteners do not allow for easy and quick installation and removal of secondary decorative items. It is often desired to quickly and easily install and remove secondary decorative items without having to modify or damage the body of the primary decorative item, and gluing, screwing, or nailing the additional items to the primary decorative items alters or could potentially damage either item. Existing fasteners such as alligator clamps allow a user to attach an item to another item without having to modify or damage the body of one of the items. Unfortunately, these existing fasteners lack a feature that allow the user to adjust the lengths and widths. In addition, most of the existing fasteners available today lack a feature to easily and securely fasten the additional items onto the primary decorative item without having to use tools. Thus, a fastener which allows additional items to be attached and detached from a primary decorative item easily and without using additional tools is beneficial and necessary.

An objective of the present invention is to provide a decorative item fastener that allows users to attach a secondary decorative item to a primary decorative item. Another objective of the present invention is to provide a fastener that allows users to secure an additional item to a primary decorative item without using tools and without having to modify or change the body of the primary decorative item and the additional item. Another objective of the present invention is to provide a fastener that can be used with decorative items of different widths and lengths. Additional advantages of the present invention are set forth in part in the description which follows and in part to be obvious from the description. Additional advantages of the present invention can be attained by means of the instrumentalities and combinations particularly pointed out in the detailed description of the present invention section. Further benefits and advantages of the present invention becomes apparent from consideration of the following detailed description given with reference to the accompanying drawings, which specify and show a preferred embodiment of the present invention.

### BRIEF DESCRIPTION OF THE DRAWINGS

FIG. 1 is a top perspective view of the present invention at the opened position.

FIG. 2 is a side view of the present invention at the opened position.

FIG. 3 is a top perspective view of the present invention at the closed position.

FIG. 4 is a side view of the present invention at the closed position.

FIG. 5 is a side view for the first arm of the present invention.

FIG. 6 is a bottom perspective view for the first arm of the present invention.

FIG. 7 is a side view for the second arm of the present invention.

FIG. 8 is a top perspective view for the second arm of the present invention.

FIG. 9 is a top view of the annular female fastener of the present invention.

FIG. 10 is a back view of the present invention, showing the plane upon which a cross sectional view is taken shown in FIG. 11.

FIG. 11 is a cross section view of the present invention taken along line A-A of FIG. 10.

### DETAIL DESCRIPTIONS OF THE INVENTION

All illustrations of the drawings are for the purpose of describing selected versions of the present invention and are not intended to limit the scope of the present invention.

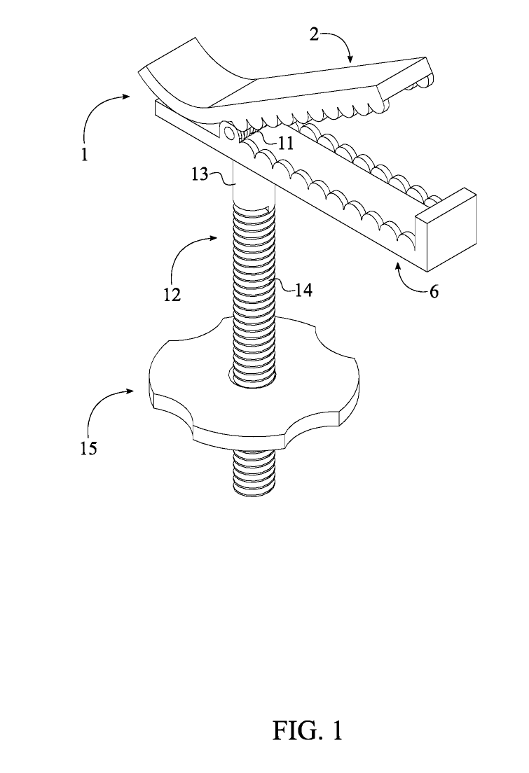

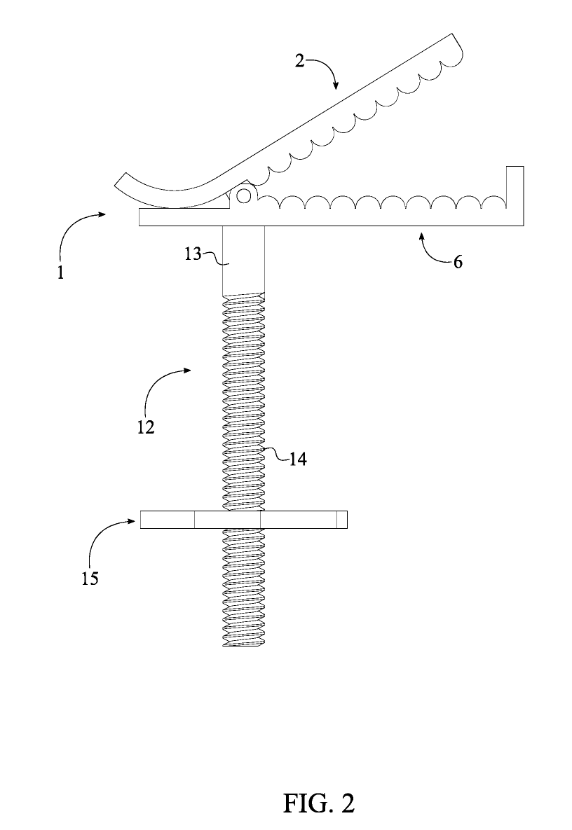

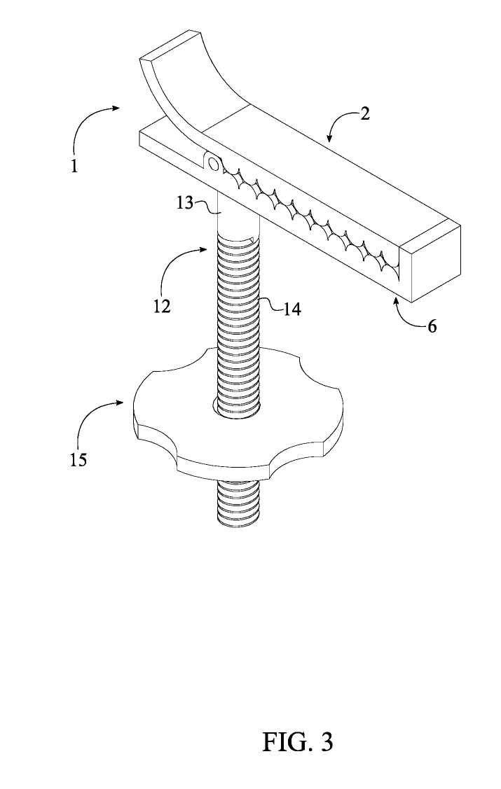

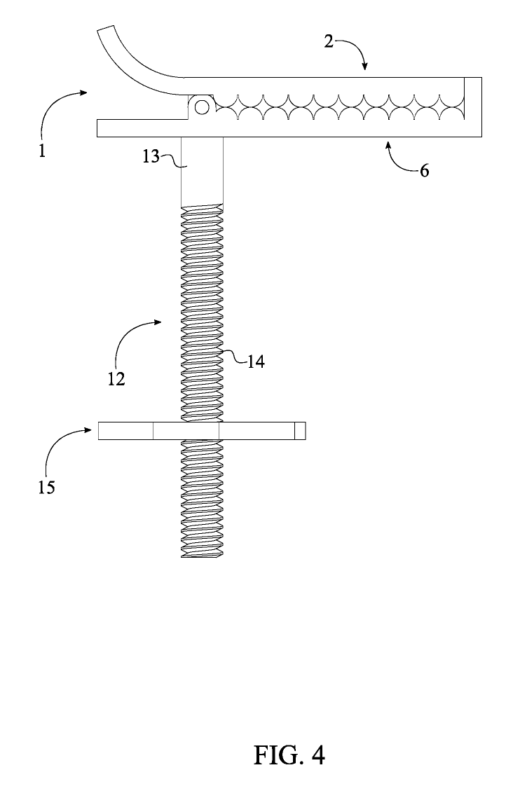

The present invention is a decorative item fastener secures a secondary decorative item to a primary decorative item, without altering the body of either decorative item, without additional tools, and universal fit for many different lengths and widths of the secondary decorative item. The present invention comprises a holder 1, a cylindrical male fastener 12, and an annular female fastener 15 as shown in FIG. 1-4. In reference to the general configuration of the present invention, the holder 1 that grips the secondary decorative item comprises a first arm 2, a second arm 6, and a recoil member 11. More specifically, the first arm 2 and the second arm 6 are tensionably and hingedly connected to each other with the recoil member 11 thus completing the structural configuration of the holder 1. As a result, the holder 1 moves to an opened position by applying an external force to the first arm 2 and the second arm 6 together, adjacent to the recoil member 11. Once the external force is released, the first arm 2 and the second arm 6 are moves to a closed position. From an end, a first section 13 of the cylindrical male fastener 12 is terminally connected to the second arm 6, opposite of the first arm 2 in order to complete the fixed connection between the holder 1 and the cylindrical male fastener 12. From the opposite end, a second section 14 of the cylindrical male fastener 12 is engaged with the annular female fastener 15 thus completing the movable engagement between the annular female fastener 15 and the cylindrical male fastener 12.

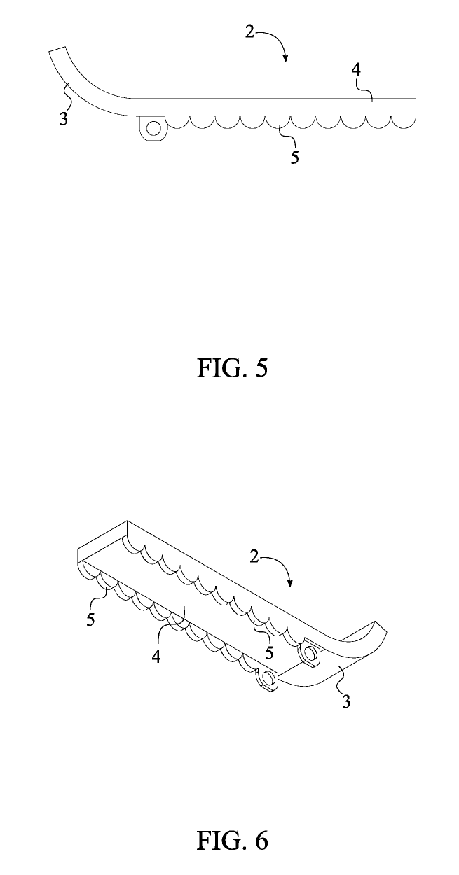

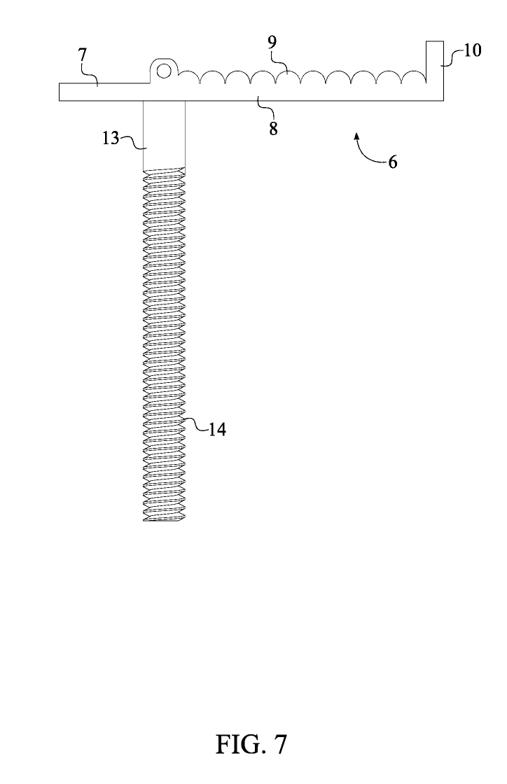

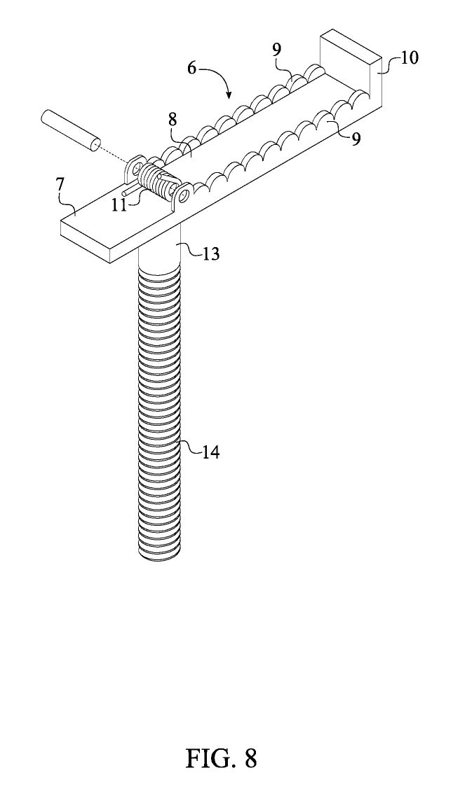

The first arm 2 and the second arm 6 function as the clamping members within the present invention as the secondary decorative item is secured within. In reference to FIG. 5-6, the first arm 2 comprises a curved section 3 and a first clamping section 4. More specifically, the curved section 3 and the first clamping section 4 are adjacently connected to each other delineating an elongated body for the first arm 2. In reference to FIG. 7-8, the second arm 6 comprises a rectangular section 7, a second clamping section 8, and a seat section 10. More specifically, the rectangular section 7 is adjacently connected to the second clamping section 8. The seat section 10 is adjacently connected to the second clamping section 8 and positioned opposite of the rectangular section 7 in such a way that the seat section 10 and the second clamping section 8 are perpendicularly positioned of each other.

The hinged connection between the first arm 2 and the second arm 6 is preferably configured through a pin. More specifically, the first arm 2 and the second arm 6 each further comprises a pair of channel bodies. The pair of channel bodies of the first arm 2 is oriented towards the second arm 6 about the rectangular section 7. The pair of channel bodies of the second arm 6 is oriented towards the first arm 2 about the curved section 3. The pair of channel bodies of the first arm 2 and the pair of channel bodies of the second arm 6 are concentrically positioned with each other. As a result, the pin is able to traverse through the pair of channel bodies of the first arm 2 and the second arm 6 thus completing the hinged connection between the first arm 2 and the second arm 6.

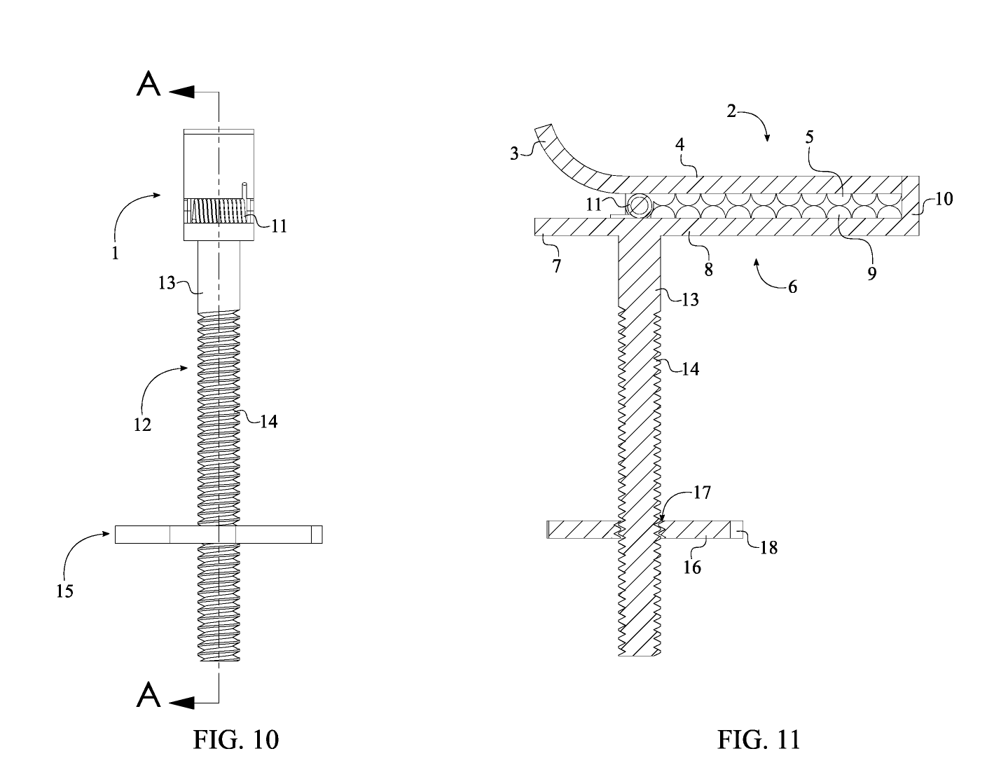

In reference to FIG. 10-11, the recoil member 11 that allows the holder 1 to be switch from the opened position to closed position and vice versa is tensionally connected to the curved section 3 and the rectangular section 7 thus orienting the curved section 3 away from the rectangular section 7. As a result, the configuration of the curved section 3 and the rectangular section 7 form a gap in between those two components allowing an individual to compress both the curved section 3 and the rectangular section 7 towards each other. When the holder 1 is at the closed position due to the spring force of the recoil member 11, a maximum linear distance is attained between terminal ends of the curved section 3 and the rectangular section 7, and the first clamping section 4 and the second clamping section 8 are compressed against each other. Additionally, the seat section 10 is flushed against a terminal end of the first clamping section 4. When the holder 1 is at the opened position due to the external force, a minimum linear distance is attained between terminal ends of the curved section 3 and the rectangular section 7, and the first clamping section 4 and the second clamping section 8 are angularly positioned of each other by the recoil member 11. The recoil member 11 of the present invention is preferably a torsion spring that tensionally connects with or places against both the first arm 2 and the second arm 6. More specifically, the torsion spring is concentrically positioned around the pin so that the terminals ends of the torsion spring can be tensionally connected with or placed against the first arm 2 and the second arm 6 However, the recoil member 11 is not limited to the torsion spring and can be any other types recoil body or mechanism that may provide a torsional force to the first arm 2 and the second arm 6 so that the present invention can maintains the closed position. In reference to FIG. 6 and FIG. 8, the present invention further comprises a pair of first teeth rows 5 and a pair of second teeth rows 9. The pair of first teeth rows 5 is connected along the first clamping section 4 and is extended from the curved section 3 in order to improve the gripping functionality with respect to the first arm 2. Since the first arm 2 is pressed against the second arm 6 during the closed position, the pair of first teeth rows 5 is oriented towards the second arm 6. The present invention further comprises a pair of first teeth rows 5. The pair of second teeth rows 9 is connected along the second clamping section 8 and is extended from the rectangular section 7 to the seat section 10 in order to improve the gripping functionality with respect to the second arm 6. Since the second arm 6 is pressed against the first arm 2 during the closed position, the pair of second teeth rows 9 is oriented towards the first arm 2. Resultantly, the pair of first teeth rows 5 and the pair of second teeth rows 9 are engaged with each other when the present invention is at the closed position thus improving the gripping functionality between the present invention and the secondary decorative item. The pair of first teeth rows 5 and the pair of second teeth rows 9 are preferably formed into a round or wavy body. However, the pair of first teeth rows 5 and the pair of second teeth rows 9 may be formed into different shapes and may be arranged in different patterns along the first clamping section 4 and the second clamping section 8.

The cylindrical male fastener 12 is an elongated body that adjustably engages with the primary decorative item. In reference to FIG. 11, the first section 13 of the cylindrical male fastener 12 is positioned adjacent to the rectangular section 7 of the second arm 6 and below the recoil member 11. As a result, the user is able to grasp and compress the curved section 3 and the rectangular section 7 together without having to interference with the cylindrical male fastener 12. The first clamping section 4 and the second clamping section 8 are then opened opposite of the recoil member 11 enabling the secondary decorative item to be secured.

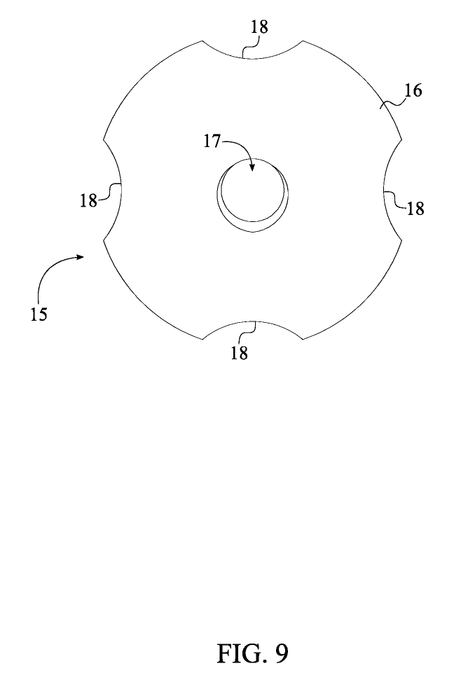

The annular female fastener 15 that functions similar to a bolt and engages with the second section 14 of the cylindrical male fastener 12 comprises a body 16, a fastener opening 17, and a plurality of notches 18. In reference to FIG. 9, the plurality of notches 18 being perimetrically positioned around the body 16 so that the user is able to grip and move the annular female fastener 15 by positioning their fingers with the plurality of notches 18. In other words, the each of the plurality of notches 18 is radially positioned around the body 16 and equally spaced apart from each other so that the user is able to comfortably position their fingers. The fastener opening 17 traverses through the body 16, preferably positioned concentric with the body 16, so that the fastener opening 17 can be threadedly engaged with the second section 14. Resultantly, clockwise rotation of the annular female fastener 15 rotatably moves the annular female fastener 15 towards the holder 1, and counter-clockwise rotation of the annular female fastener 15 rotatably moves the annular female fastener 15 away from the holder 1.

Although the invention has been explained in relation to its preferred embodiment, it is to be understood that many other possible modifications and variations can be made without departing from the spirit and scope of the invention as hereinafter claimed.

What is claimed is:

1. A decorative item fastener comprises:
a holder;
a cylindrical male fastener;
an annular female fastener;
the holder comprises a first arm, a second arm, and a recoil member;
the first arm and the second arm being tensionably and hingedly connected to each other with the recoil member, wherein the holder is movable between a closed position and an opened position;
a first section of the cylindrical male fastener being terminally connected to the second arm, opposite of the first arm; and
a second section of the cylindrical male fastener being engaged with the annular female fastener.

2. The decorative item fastener as claimed in claim 1 comprises:
the first arm comprises a curved section and a first clamping section; and
the curved section and the first clamping section being adjacently connected to each other.

3. The decorative item fastener as claimed in claim 2 comprises:
a pair of first teeth rows;
the pair of first teeth rows being connected along the first clamping section;
the pair of first teeth rows being extended from the curved section; and
the pair of first teeth rows being oriented towards the second arm.

4. The decorative item fastener as claimed in claim 1 comprises:
the second arm comprises a rectangular section, a second clamping section, and a seat section;
the rectangular section being adjacently connected to the second clamping section;
the seat section being adjacently connected to the second clamping section, opposite of the rectangular section; and
the seat section and the second clamping section being perpendicularly positioned of each other.

5. The decorative item fastener as claimed in claim 4 comprises:
a pair of second teeth rows;
the pair of second teeth rows being connected along the second clamping section;
the pair of second teeth rows being extended from the rectangular section to the seat section; and
the pair of second teeth rows being oriented towards the first arm.

6. The decorative item fastener as claimed in claim 1 comprises:
the recoil member being tensionally connected to a curved section of the first arm and a rectangular section of the second arm; and
the curved section being oriented away from the rectangular section.

7. The decorative item fastener as claimed in claim 1 comprises:
the closed position; and
a first clamping section of the first arm and a second clamping section of the section arm being compressed against each other.

8. The decorative item fastener as claimed in claim 1 comprises:
the opened position; and
a first clamping section of the first arm and a second clamping section of the section arm being angularly positioned of each other.

9. The decorative item fastener as claimed in claim 1, wherein the first section being positioned adjacent to a rectangular section of the second arm.

10. The decorative item fastener as claimed in claim 1 comprises:
the annular female fastener comprises a body, a fastener opening, and a plurality of notches;
the plurality of notches being perimetrically positioned around the body;
the fastener opening traverses through the body; and
the fastener opening being threadedly engaged with the second section.

11. A decorative item fastener comprises:
a holder;
a cylindrical male fastener;
an annular female fastener;
the holder comprises a first arm, a second arm, and a recoil member;
the first arm and the second arm being tensionably and hingedly connected to each other with the recoil member, wherein the holder is movable between a closed position and an opened position;
the first arm comprises a curved section and a first clamping section;
the second arm comprises a rectangular section, a second clamping section, and a seat section;
the curved section and the first clamping section being adjacently connected to each other;
the rectangular section being adjacently connected to the second clamping section;
the seat section being adjacently connected to the second clamping section, opposite of the rectangular section;
the seat section and the second clamping section being perpendicularly positioned of each other;
a first section of the cylindrical male fastener being terminally connected to the second arm, opposite of the first arm; and
a second section of the cylindrical male fastener being engaged with the annular female fastener.

12. The decorative item fastener as claimed in claim 11 comprises:
a pair of first teeth rows;
the pair of first teeth rows being connected along the first clamping section;
the pair of first teeth rows being extended from the curved section; and
the pair of first teeth rows being oriented towards the second arm.

13. The decorative item fastener as claimed in claim 11 comprises:
a pair of second teeth rows;
the pair of second teeth rows being connected along the second clamping section;
the pair of second teeth rows being extended from the rectangular section to the seat section; and
the pair of second teeth rows being oriented towards the first arm.

14. The decorative item fastener as claimed in claim 11 comprises:
the recoil member being tensionally connected to the curved section of the first arm and the rectangular section of the second arm; and
the curved section being oriented away from the rectangular section.

15. The decorative item fastener as claimed in claim 11 comprises:
the closed position; and
the first clamping section of the first arm and the second clamping section of the section arm being compressed against each other.

16. The decorative item fastener as claimed in claim 11 comprises:
the opened position; and
the first clamping section of the first arm and the second clamping section of the section arm being angularly positioned of each other.

17. The decorative item fastener as claimed in claim 11, wherein the first section being positioned adjacent to the rectangular section of the second arm.

18. The decorative item fastener as claimed in claim 11 comprises:
the annular female fastener comprises a body, a fastener opening, and a plurality of notches;
the plurality of notches being perimetrically positioned around the body;
the fastener opening traverses through the body; and
the fastener opening being threadedly engaged with the second section.
